(19) United States
(12) Patent Application Publication
(10) Pub. No.: US 2010/0316206 A1
(43) Pub. Date: Dec. 16, 2010

(54) PHONE SERVICE METHOD AND SERVER FOR IMPLEMENTING THE SAME

(76) Inventors: Ming-Feng CHANG, Hsinchu City (TW); Yi-Bing Lin, Hsinchu (TW)

Correspondence Address: REED SMITH LLP, P.O. BOX 488, PITTSBURGH, PA, 15230-0488, US

(21) Appl. No.: 12/686,517

(22) Filed: Jan. 13, 2010

(30) Foreign Application Priority Data
Jun. 12, 2009 (TW) 098119727

(51) Int. Cl. H04M 3/42

(52) U.S. Cl. 379/201.01

(57) ABSTRACT

A phone service method includes: receiving a subscription request from a subscriber, which contains a phone number of the subscriber and a phone number specified by the subscriber; in response to the subscription request, assigning a temporary phone number to the phone number of the subscriber with reference to the phone number specified by the subscriber and a mapping table; and storing the temporary phone number, the phone number of the subscriber, the phone number specified by the subscriber in the mapping table, thereby mapping the temporary phone number to the phone number of the subscriber for the communications with the phone number specified by the subscriber. A server that implements the phone service method is also disclosed.

### CROSS-REFERENCE TO RELATED APPLICATION

This application claims priority of Taiwanese application no. 098119727, filed on Jun. 12, 2009.

### BACKGROUND OF THE INVENTION

1. Field of the Invention

This invention relates to a phone service method and server for implementing the same.

2. Description of the Related Art

In a conventional method, a unique temporary phone number is assigned for each phone number of a subscriber.

The aforementioned conventional method is disadvantageous in that many temporary phone numbers are required. In addition, when a subscriber cancels his/her subscription, a certain period of time, i.e., aging time, must pass before the temporary phone number assigned thereto can be reassigned to another subscriber.

### SUMMARY OF THE INVENTION

Therefore, an object of the present invention is to provide a phone service method that can overcome the aforesaid drawbacks of the prior art.

Another object of the present invention is to provide a server that implements the phone service method.

According to an aspect of the present invention, a phone service method is implemented by a server configured with a mapping table, and comprises: A) receiving a subscription request from a subscriber, the subscription request containing a phone number of the subscriber and a phone number specified by the subscriber; B) in response to the subscription request, assigning a temporary phone number to the phone number of the subscriber with reference to the phone number specified by the subscriber and a specified phone number field of the mapping table; and C) storing the temporary phone number, the phone number of the subscriber, the phone number specified by the subscriber in a temporary phone number field, a subscriber's phone number field, and the specified phone number field of the mapping table, respectively, thereby mapping the temporary phone number assigned in step B) to the phone number of the subscriber for setting up the communications with the phone number specified by the subscriber received in step A).

According to another aspect of the present invention, a server comprises a memory device and a processing device. The memory device stores therein a mapping table that defines a temporary phone number field, a subscriber's phone number field, and a specified phone number field. The processing device is coupled to the memory device, and is operable so as to receive a subscription request from a subscriber, the subscription request containing a phone number of the subscriber and a phone number specified by the subscriber, so as to assign a temporary phone number to the phone number of the subscriber with reference to the phone number specified by the subscriber and the specified phone number field of the mapping table, and so as to store the temporary phone number assigned thereby, and the phone number of the subscriber and the phone number specified by the subscriber received thereby in the temporary phone number field, the subscriber's phone number field, and the specified phone number field of the mapping table, respectively, thereby mapping the temporary phone number assigned by the processing device to the phone number of the subscriber for setting up the communications with the phone number specified by the subscriber received by the processing device.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit block diagram of the preferred embodiment of a server according to the present invention; and

FIGS. 2 to 5 are flow charts of the preferred embodiment of a phone service method according to the present invention to be implemented using the server shown in FIG. 1.

### DETAILED DESCRIPTION OF THE PREFERRED EMBODIMENT

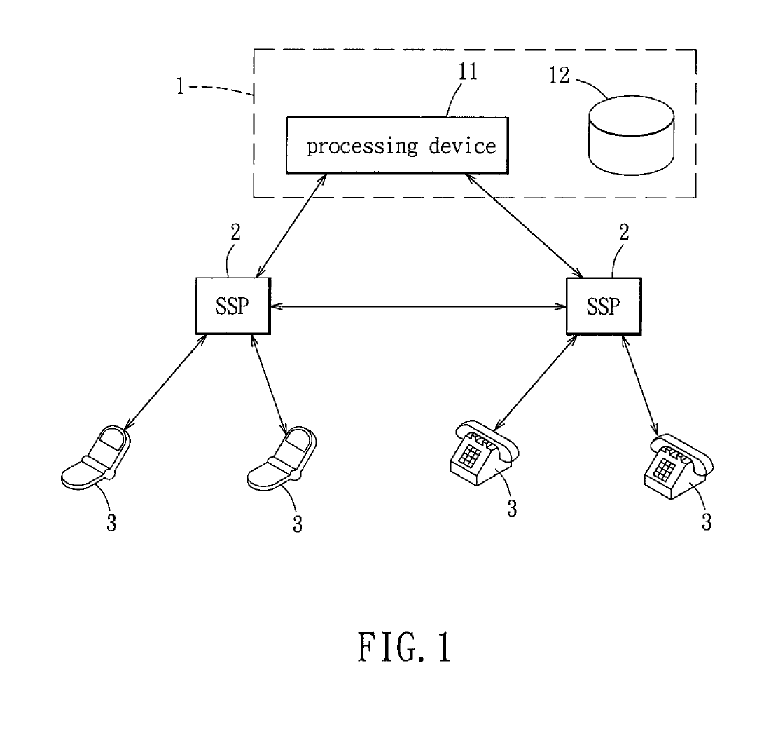

Referring to FIG. 1, the preferred embodiment of a server 1 according to this invention is shown to include a processing device 11 and a memory device 12.

The server 1 of this invention is employed in an intelligent telephony network, a.k.a., Intelligent Network (IN).

The intelligent telephony network includes a plurality of service switching points (SSP) 2 that are connected to each other and that each is connected to a plurality of user terminals 3.

The processing device 11 is connected to the SSP 2 of the intelligent telephony network. In this embodiment, the processing device 11 is implemented in a service control point (SCP) of the intelligent telephony network.

The memory device 12 is connected to the processing device 11, and stores therein a mapping table and a list of predetermined temporary phone numbers. In this embodiment, as illustrated in Table I, each mapping record in the mapping table defines a temporary phone number field, a subscriber's phone number field, and a specified phone number field.

TABLE I

| Temporary | Subscriber's | Specified |
|---|---|---|
| phone number | phone number | phone number |
| 0900-000000 | 0955-111111 | 0922-222222 |
| 0900-000000 | 0955-111111 | 0922-333333 |
| 0900-000001 | 0955-111111 | 0922-444444 |
| 0900-000000 | 0999-999999 | 0922-444444 |
| 0900-000001 | 0999-999999 | 0922-222222 |

The processing device 11 provides phone services, such as a temporary phone number subscription service, to first and second users (not shown) of the user terminals 3, in a manner that will be described hereinafter.

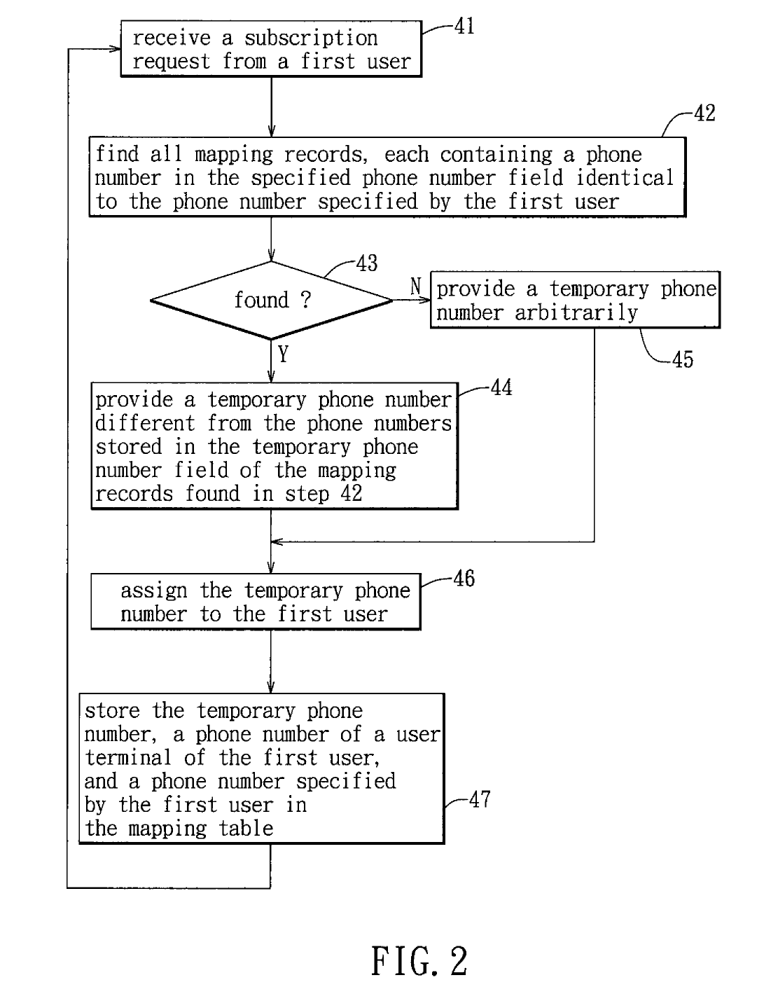

The preferred embodiment of a phone service method to be implemented by the aforementioned server 1 according to this invention will now be described with further reference to FIG. 2.

In step 41, the processing device 11 receives a subscription request from the user terminal 3 of the first user, i.e., a subscriber, through the SSP 2.

The subscription request received in this step contains a phone number of the user terminal 3 of the first user, and a phone number specified by the first user, e.g., a phone number of the user terminal 3 of the second user.

In step 42, in response to the subscription request, the processing device 11 finds all mapping records in the mapping table, each containing a phone number in the specified phone number field identical to the phone number specified by the first user received in step 41.

In step 43, when the mapping records are found in step 42, the flow proceeds to step 44. Otherwise, i.e., there is no mapping record found in step 42, the flow proceeds to step 45.

In step 44, the processing device 11 provides a temporary phone number different from the phone numbers stored in the temporary phone number field of the mapping records found in step 42.

In this embodiment, the temporary phone number provided in this step is selected from the list of predetermined temporary phone numbers.

In step 45, the processing device 11 provides a temporary phone number by, e.g., selecting arbitrarily from the list of predetermined temporary phone numbers.

In an alternative embodiment, the temporary phone number provided in this step is selected arbitrarily from the temporary phone number field of the mapping table.

In step 46, the processing device 11 assigns the temporary phone number provided in step 44 or 45 to the phone number of the user terminal 3 of the first user for setting up the communications with the phone number specified by the first user received in step 41.

In step 47, the processing device 11 stores the temporary phone number assigned in step 46, the phone number of the user terminal 3 of the first user, and the phone number specified by the first user received in step 41 in the temporary phone number field, the subscriber's phone number field, and the specified phone number field of the mapping table, respectively, whereby the temporary phone number assigned in step 46 is mapped to the phone number of the user terminal 3 of the first user for setting up the communications with the phone number specified by the first user received in step 41. Thereafter, the flow goes back to step 41 for processing a next subscription request.

From the above description, as illustrated in Table I, the phone service method of this invention maps the same temporary phone numbers, i.e., “0900-000000”, to different subscriber's phone numbers, i.e., “0955-111111” and “0999-999999”, stored in the subscriber's phone number field of the mapping table, for setting up the communications with different phone numbers, i.e., “0922-222222” and “0922-444444”, stored in the specified phone number field of the mapping table. As such, the phone service method of this invention requires less predetermined temporary phone numbers in the list of predetermined temporary phone numbers.

Furthermore, when the phone number specified by the first user received in step 41 is “0922-444444”, the processing device 11 finds all mapping records that store the specified phone number field the phone number “0922-444444” and then assigns a temporary phone number, which is different from the temporary phone numbers, i.e., “0900-000001” and “0900-000000”, that are stored in the temporary phone number field of the mapping records found in step 42, to the phone number of the user terminal 3 of the first user.

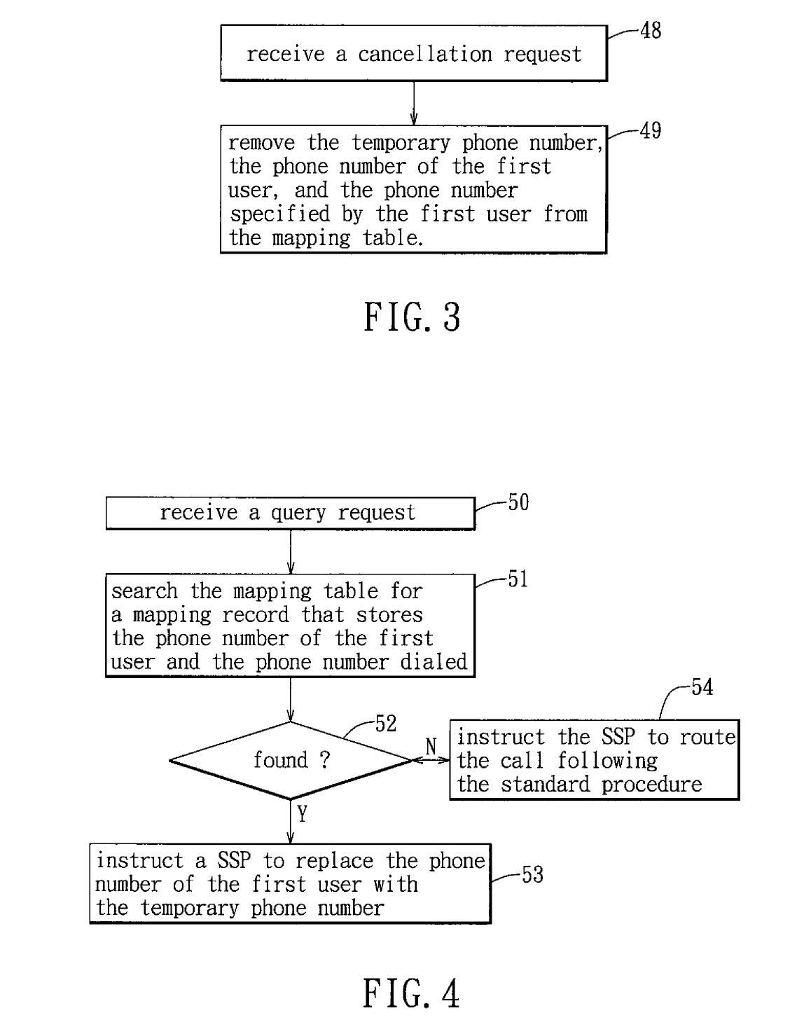

As illustrated in FIG. 3, the phone service method further includes the following steps.

In step 48, receiving a cancellation request from the user terminal 3 of the first user through the SSP 2, the cancellation request containing the phone number of the user terminal 3 of the first user and the phone number specified by the first user received in step 41.

In step 49, in response to the cancellation request, removing the mapping record that stores the temporary phone number, the phone number of the user terminal 3 of the first user, and the phone number specified by the first user from the mapping table.

As illustrated in FIG. 4, the phone service method further includes the following steps of:

When a phone number is dialed on the user terminal 3 of the first user, the SSP 2 receives a voice call request from the user terminal 3 of the first user, that contains the phone number of the user terminal 3 of the first user and a phone number dialed on the user terminal 3 of the first user, e.g., the phone number of the user terminal 3 of the second user.

In response to the voice call request, the SSP 2 determines whether the first user is a temporary phone number subscriber. If so, the SSP 2 queries the processing device 11 with the phone number of the user terminal 3 of the first user and the phone number dialed on the user terminal 3 of the first user. Otherwise, the SSP 2 routes the call according to the standard procedure.

In step 50, the processing device 11 receives a query request from the SSP 2, that contains the phone number of the user terminal 3 of the first user and the phone number dialed on the user terminal 3 of the first user, e.g., the phone number of the user terminal 3 of the second user.

In step 51, in response to the query request, the processing device 11 searches the mapping table for a mapping record that stores the phone number of the user terminal 3 of the first user and the phone number dialed on the user terminal 3 of the first user in the subscriber's phone number field and the specified phone number field, respectively.

In step 52, when the mapping record is found in step 51, the temporary phone number stored in the temporary phone number field of the found mapping record is mapped to the phone number of the user terminal 3 of the first user, and the flow proceeds to step 53. Otherwise, i.e., there is no mapping record found in step 51, the flow proceeds to step 54.

In step 53, the processing device 11 instructs the SSP 2 to replace the phone number of the user terminal 3 of the first user received in step 50 with the temporary phone number, whereby the SSP 2 replaces the phone number of the user terminal 3 of the first user with the temporary phone number in the temporary phone number field of the found mapping record, and routes the call to the user terminal 3 of the second user, whereby the user terminal 3 of the second user indicates the temporary phone number in the temporary phone number field of the found mapping record, and whereby the second user is notified of the temporary phone number in the temporary phone number field of the found mapping record.

In step 54, the processing device 11 instructs the SSP 2 to route the call according to the standard procedure.

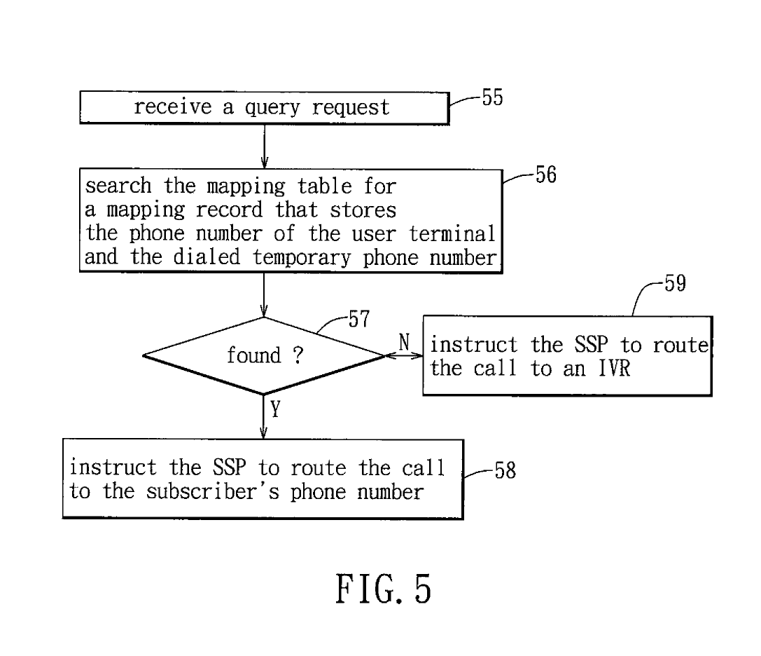

As illustrated in FIG. 5, the phone service method further includes the following steps.

When a phone number is dialed on the user terminal 3, the SSP 2 receives a voice call request from the user terminal 3, that contains a phone number of the user terminal 3 and a phone number dialed on the user terminal 3, e.g., the temporary phone number stored in the temporary phone number field of the mapping table and mapped to the phone number of the user terminal 3 of the first user.

In response to the voice call request, the SSP 2 determines whether the dialed phone number received by the SSP 2 is a temporary phone number. If so, the SSP 2 queries the processing device 11 with the phone number of the user terminal 3 and the dialed temporary phone number. Otherwise, the SSP 2 routes the call according to the standard procedure.

In step 55, the processing device 11 receives a query request from the SSP 2, that contains the phone number of the user terminal 3 and the dialed temporary phone number.

In step 56, in response to the query request, the processing device 11 searches the mapping table for a mapping record that stores the phone number of the user terminal 3 and the dialed temporary phone number in the specified phone number field and the temporary phone number field, respectively.

In step 57, when a mapping record is found in step 56, the temporary phone number is mapped to a subscriber's phone number in the subscriber's phone number field of the found mapping record, and the flow proceeds to step 58. Otherwise, i.e., there is no mapping record found in step 56, the flow proceeds to step 59.

In step 58, the processing device 11 instructs the SSP 2 to route the call to the subscriber's phone number in the subscriber's phone number field of the found mapping record, i.e., the phone number of the user terminal 3 of the first user.

In step 59, the processing device 11 instructs the SSP 2 to route the call to an interactive voice response (IVR), whereby the IVR indicates that the call cannot be established through the user terminal 3. As such, privacy of the first user is protected.

It can be readily appreciated by those skilled in the art that the aforementioned phone service method is applicable as well for transmitting a short message or a multimedia message between the user terminals 3 of the first and second users.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A phone service method to be implemented by a server, the server being configured with a mapping table that defines a temporary phone number field, a subscriber's phone number field, and a specified phone number field, said phone service method comprising:
A) receiving a subscription request from a subscriber, the subscription request containing a phone number of the subscriber and a phone number specified by the subscriber;
B) in response to the subscription request, assigning a temporary phone number to the phone number of the subscriber with reference to the phone number specified by the subscriber and the specified phone number field of the mapping table; and
C) storing the temporary phone number, the phone number of the subscriber, the phone number specified by the subscriber in the temporary phone number field, the subscriber's phone number field, and the specified phone number field of the mapping table, respectively, thereby mapping the temporary phone number assigned in step B) to the phone number of the subscriber for the communications with the phone number specified by the subscriber received in step A).

2. The phone service method as claimed in claim 1, wherein, step B), includes the sub-step of:
b1) finding all mapping records in the mapping table, each containing a phone number in the specified phone number field identical to the phone number specified by the subscriber received in step A), and
b2) when the mapping records are found in sub-step b1), providing a phone number different from phone numbers stored in the temporary phone number field of the mapping records found in sub-step b1), wherein the temporary phone number assigned in step B) is the phone number provided in sub-step b2).

3. The phone service method as claimed in claim 2, wherein the phone number provided in sub-step b2) is selected from a list of predetermined temporary phone numbers configured in the server.

4. The phone service method as claimed in claim 2, wherein step B) further includes the sub-step of:
b3) when there is no mapping record found in sub-step b1), providing a phone number by arbitrarily selecting from a list of predetermined temporary phone numbers configured in the server, wherein the temporary phone number assigned in step B) is the phone number provided in sub-step b3).

5. The phone service method as claimed in claim 2, wherein step B) further includes the sub-step of:
b3) when there is no mapping record found in sub-step b1), providing a phone number by arbitrarily selecting from the temporary phone number field of the mapping table, wherein the temporary phone number assigned in step B) is the phone number provided in sub-step b3).

6. The phone service method as claimed in claim 1, further comprising the steps of:
D) receiving a cancellation request from the subscriber, the cancellation request containing the phone number of the subscriber and the phone number specified by the subscriber received in step A); and
E) in response to the cancellation request, removing a mapping record that contains the temporary phone number, the phone number of the subscriber, and the phone number specified by the subscriber stored in step C) from the mapping table.

7. The phone service method as claimed in claim 1, when a Service Switching Point (SSP) connected to the server receives a voice call request from the subscriber, the SSP queries the server with the phone number of the subscriber and the phone number dialed by the subscriber, the method further comprising the steps of:
F) receiving a query request from the SSP, the query request containing the phone number of the subscriber and the phone number dialed by the subscriber;
G) in response to the query request, searching the mapping table for a mapping record that stores the phone number of the subscriber and the phone number dialed by the subscriber in the subscriber's phone number field and the specified phone number field, respectively; and
H) when the mapping record is found in step G), instructing the SSP to replace the phone number of the subscriber with the temporary phone number stored in the temporary phone number field of the found mapping record.

8. The phone service method as claimed in claim 1, when a SSP connected to the server receives a voice call request from an user, the SSP queries the server with the phone number of the user and the phone number dialed by the user, the method further comprising the steps of:
I) receiving a query request from the SSP, the query request containing the phone number of the user and the phone number dialed by the user;
J) in response to the query request, searching the mapping table for a mapping record that stores the phone number of the user and the phone number dialed by the user in the specified phone number field and the temporary phone number field, respectively; and
K) when the mapping record is found in step J), instructing the SSP to route the call to the phone number stored in the subscriber field of the found mapping record.

9. A server, comprising:
a memory device storing therein a mapping table that defines a temporary phone number field, a subscriber's phone number field, and a specified phone number field; and
a processing device coupled to said memory device, and adapted to receive a subscription request from a subscriber, the subscription request containing a phone number of the subscriber and a phone number specified by the subscriber,
wherein, in response to the subscription request, said processing device is configured to assign a temporary phone number to the phone number of the subscriber with reference to the phone number specified by the subscriber and the specified phone number field of the mapping table, and to store the temporary phone number assigned thereby, and the phone number of the subscriber and the phone number specified by the subscriber received thereby in the temporary phone number field, the subscriber's phone number field, and the specified phone number field of the mapping table, respectively, thereby mapping the temporary phone number assigned by said processing device to the phone number of the subscriber for the communications with the phone number specified by the subscriber received by said processing device.

10. The server as claimed in claim 9, wherein, in response to the subscription request, said processing device is configured to find all mapping records in the mapping table, each containing a phone number in the specified phone number field identical to the phone number specified by the subscriber received by said processing device, and when the mapping records are found, said processing device is configured to provide a phone number different from phone numbers stored in the temporary phone number field of the found mapping records, the temporary phone number assigned by said processing device being the phone number provided by said processing device.

11. The server as claimed in claim 10, wherein said memory device further stores therein a list of predetermined temporary phone numbers, the phone number provided by said processing device being selected from the list of predetermined temporary phone numbers.

12. The server as claimed in claim 10, wherein said memory device further stores therein a list of predetermined temporary phone numbers, when there is no mapping record found, said processing device is configured to provide a phone number by arbitrarily selecting from the list of predetermined temporary phone numbers, and the temporary phone number assigned by said processing device being the phone number provided by said processing device.

13. The server as claimed in claim 10, wherein when there is no mapping record found, said processing device is configured to provide a phone number by arbitrarily selecting from the temporary phone number field of the mapping table, and the temporary phone number assigned by said processing device being the phone number provided by said processing device.

14. The server as claimed in claim 9, wherein:
said processing device is further configured to receive a cancellation request from the subscriber, the cancellation request containing the phone number of the subscriber and the phone number specified by the subscriber received by said processing device; and
in response to said cancellation request, said processing device is configured to remove a mapping record that contains the temporary phone number, the phone number of the subscriber, and the phone number specified by the subscriber stored by said processing device from the mapping table.

15. The server as claimed in claim 9, wherein when a Service Switching Point (SSP) connected to the server receives a voice call request from the subscriber, the SSP queries the server with the phone number of the subscriber and the phone number dialed by the subscriber, said processing device is further configured to receive a query request from a SSP, the query request containing the phone number of the subscriber and the phone number dialed by the subscriber, and in response to the query request, said processing device is configured to search the mapping table for a mapping record that stores the phone number of the subscriber and the phone number dialed by the subscriber in the subscriber's phone number field and the specified phone number field, respectively, when the mapping record is found, said processing device is configured to instruct the SSP to replace the phone number of the subscriber with the temporary phone number stored in the temporary phone number field of the found mapping record.

16. The server as claimed in claim 9, wherein when a SSP connected to the server receives a voice call request from an user, the SSP queries the server with the phone number of the user and the phone number dialed by the user, said processing device is further configured to receive a query request from a SSP, the query request containing the phone number of the user and the phone number dialed by the user, and in response to the query request, said processing device is configured to search the mapping table for a mapping record that stores the phone number of the user and the phone number dialed by the user in the specified phone number field and the temporary phone number field, respectively, when the mapping record is found, said processing device is configured to instruct the SSP to route the call to the phone number stored in the subscriber field of the found mapping record.
